(19) United States
(12) Patent Application Publication
(10) Pub. No.: US 2014/0050895 A1
(43) Pub. Date: Feb. 20, 2014

(54) GLUE-FREE VINYL TILE

(71) Applicant: MIN-SHENG HSUEH, KAOHSIUNG CITY (TW)

(72) Inventor: MIN-SHENG HSUEH, KAOHSIUNG CITY (TW)

(73) Assignee: NAN SING PLASTICS CORPORATION, KAOHSIUNG CITY (TW)

(21) Appl. No.: 13/589,318

(22) Filed: Aug. 20, 2012

(51) Int. Cl. E04F 13/18; B32B 3/30

(52) U.S. Cl. 428/172

(57) ABSTRACT

A glue-free vinyl tile has a scratch proof layer, an abrasion proof layer, a printing layer, an upper PVC layer, a fiber layer, a lower PVC layer, and an anti-slip layer. The anti-slip layer has multiple mounting segments formed on the anti-slip layer, and the mounting segments make a bottom of the tile uneven. When the glue-free vinyl the is installed, the tile is put on the ground. With the uneven bottom caused by the mounting segments, the abrasion force enhances, and makes the tile horizontally connected tightly to the ground. Because the tile is not vertically connected tightly to the ground, when the tile is removed, the tile is taken up easily without being damaged, and the ground is not damaged, too. Therefore, the glue-free vinyl tile is easy to be installed and removed, can be reused repeatedly and is more friendly to the environment.

### BACKGROUND OF THE INVENTION

1. Field of the Invention

The present invention relates to a the on the ground, especially to a glue-free vinyl tile that is reusable and is more friendly to the environment.

2. Description of the Prior Arts

Conventional tiles comprise a scratch proof layer, an abrasion proof layer, a printing layer and a PVC layer arranged in sequence from top to bottom. The scratch proof layer and the abrasion proof layer protect the tile from damage. The printing layer provides the tile with colors and patterns. The scratch proof layer is usually made of polyurethane acrylic resin, and the abrasion proof layer and the printing layer are usually made of PVC. The PVC layer is the thickest and occupies the most volume of the tile.

When the conventional tile is being installed, the most common way is to adhere a bottom of the tile to the ground. However, the Volatile Organic Compounds (VOCs) in the glue will cause the indoor air pollution, which harms the human health. Besides, when the tile is going to be removed, all of the tile would be damaged because of the separation and coming-off of the glue backing, As a result, the damaged tile is not reusable and not eco-friendly Additionally, after the tile is removed, some glue still remain on a surface of the ground, and the residual glue can be removed by some chemical solvent such as cleaning naphtha, and those chemical solvent are not eco-friendly too. Furthermore, the ground may be damaged because of the separation of the tile, which makes the ground hard to match other tile again.

To overcome the shortcomings, the present invention provides a glue-free vinyl tile to overcome or obviate the aforementioned problems.

### SUMMARY OF THE INVENTION

The main objective of the present invention is to provide a glue-free vinyl tile that is reusable and is more friendly to the environment.

The glue-free vinyl tile in accordance with the present invention has a scratch proof layer, an abrasion proof layer, a printing layer, an upper PVC layer, a fiber layer, a lower PVC layer, and an anti-slip layer arranged in sequence from top to bottom. The anti-slip layer has multiple mounting segments formed on a bottom of the anti-slip layer, and the mounting segments make a bottom of the tile uneven. When the glue-free vinyl tile is installed, the tile is put on the ground. With the uneven bottom caused by the mounting segments, the abrasion force between the tile and the ground enhances, and makes the tile horizontally connected tightly to the ground. Because the tile is not vertically connected tightly to the ground, when the tile is going to be removed, the tile is taken up easily without being damaged, and a surface of the ground is not damaged since there exists no any glue on the surface of the ground. Therefore, the glue-free vinyl tile as described is easy to be installed and removed, can be reused repeatedly and is more friendly to the environment.

Other objectives, advantages and novel features of the invention will become more apparent from the following detailed description when taken in conjunction with the accompanying drawings.

### BRIEF DESCRIPTION OF THE DRAWINGS

FIG. 1 is a side view in partial section of a first embodiment of a glue-free vinyl tile in accordance with the present invention;

FIG. 2 is an enlarged side view in partial section of the glue-free vinyl tile in FIG. 1;

FIG. 3 is a partial perspective view of the glue-free vinyl tile in FIG. 1;

FIG. 4 is a partial bottom view of the glue-free vinyl tile in FIG. 1;

FIG. 5 is a partial perspective view of a second embodiment of a glue-free vinyl tile in accordance with the present invention;

FIG. 6 is a partial bottom view of a third embodiment of a glue-free vinyl tile in accordance with the present invention;

FIG. 7 is a partial bottom view of a fourth embodiment of a glue-free vinyl tile in accordance with the present invention;

FIG. 8 is a partial bottom view of a fifth embodiment of a glue-free vinyl tile in accordance with the present invention;

FIG. 9 is a partial bottom view of a sixth embodiment of a glue-free vinyl tile in accordance with the present invention;

FIG. 10 is a partial bottom view of a. seventh embodiment of a glue-free vinyl tile in accordance with the present invention;

FIG. 11 is a partial bottom view of an eighth embodiment of a glue-free vinyl tile in accordance with the present invention; and

FIG. 12 is an operational view of the glue-free vinyl tile in FIG. 1, showing the directions of the force.

### DETAILED DESCRIPTION OF THE PREFERRED EMBODIMENTS

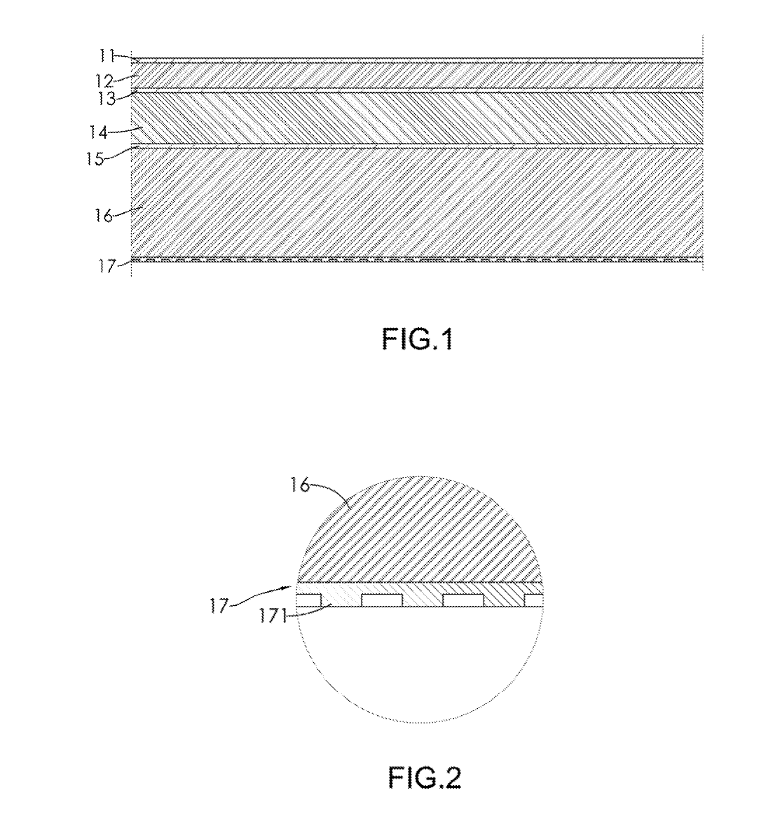

With reference to FIG. 1, a first embodiment of a glue-free vinyl the in accordance with the present invention comprises a scratch proof layer 11, an abrasion proof layer 12, a printing layer 13, an upper PVC layer 14, a fiber layer 15, a lower PVC layer 16, and an anti-slip layer 17.

The abrasion proof layer 12 is attached to a bottom of the scratch proof layer 11.

The printing layer 13 is attached to a bottom of the abrasion proof layer 12.

The upper PVC layer 14 is attached to a bottom of the printing layer 13.

The fiber layer 15 is attached to a bottom of the upper PVC layer 14. In a preferred embodiment, the position of the fiber layer 15 is above the middle height of the tile, and the fiber layer 15 is made of glass fiber. However, the fiber layer 15 may be made of other materials such as fabric with good strength or non-woven fabric.

The lower PVC layer 16 is attached to a bottom of the fiber layer 15.

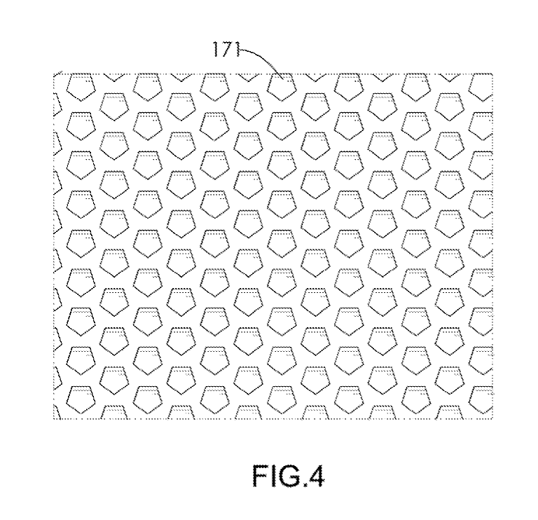

With reference to FIGS. 1 to 4, the anti-slip layer 17 is attached to a bottom of the lower PVC layer 16, and has multiple mounting segments 171. The mounting segments 171 are formed on a bottom of the anti-slip layer 17, and are arranged in order. In a preferred embodiment, the anti-slip layer 17 is made of elastomer.

When the glue-free vinyl tile as described is installed, the tile is put on the ground. With an uneven bottom of the tile caused by the mounting 22. segments 171, the abrasion force between the tile and the ground enhances, and makes the tile horizontally connected tightly to the ground. Because the tile is not vertically connected tightly to the ground, when the tile is going to be removed, the tile is taken up easily without being damaged, and a surface of the ground is not damaged by residual glue as well. Therefore, the glue-free vinyl tile as described is easy to be installed and removed, can be reused repeatedly and is more friendly to the environment.

Furthermore, the present invention is installed without using glue, so the type of the ground is not limited. The tile can be used in various kinds of ground surfaces, such as bricks, wood, marble, metal, glass or concrete.

Moreover, among all the layers, the scratch proof layer 11 and the abrasion proof layer 12 are the softest ones, and the PCV layers 14, 16 are the heaviest ones. Because the fiber layer 15 is installed between the PVC layers 14, 16 and the glass fiber layer 15 will not contract, the fiber layer 15 can prevent the PVC layers 14. 16 from being shrunk or deformed, and support the whole shape keep well. Besides, because of the glass fiber of the fiber layer 15, the glue-free vinyl tile has fine dimension stability, and is not deformed easily by thermal expansion and contraction during the different seasons. The glue-free vinyl tile is not shrunk easily after long time of using., and has longer lifespan.

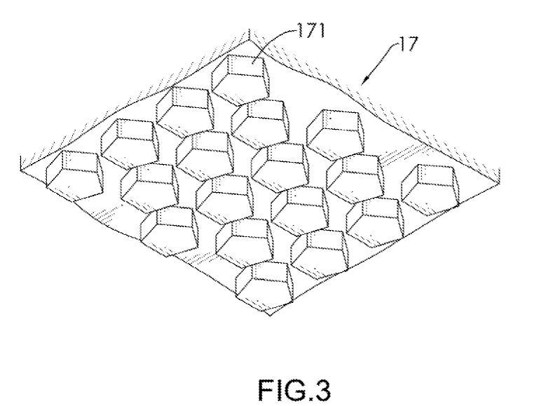

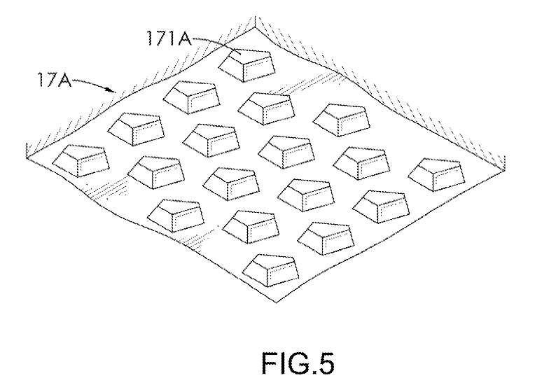

The mounting segment 171 may be formed in different configurations. In one embodiment as shown in FIG. 3, each mounting segment 171 is a protrusion. In one embodiment as shown in FIG. 5, each mounting segment 171A of the anti-slip layer 17A is a recess.

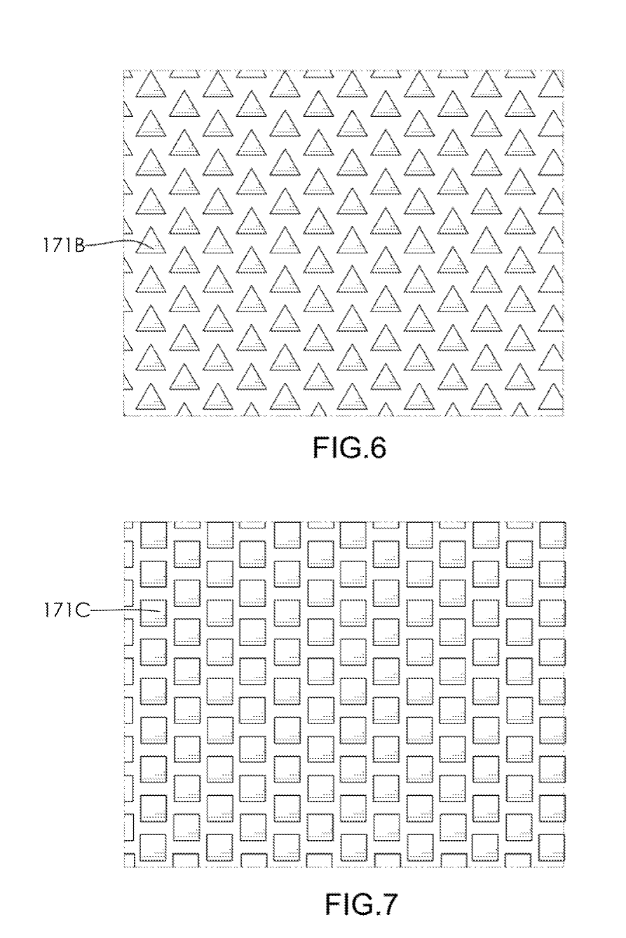

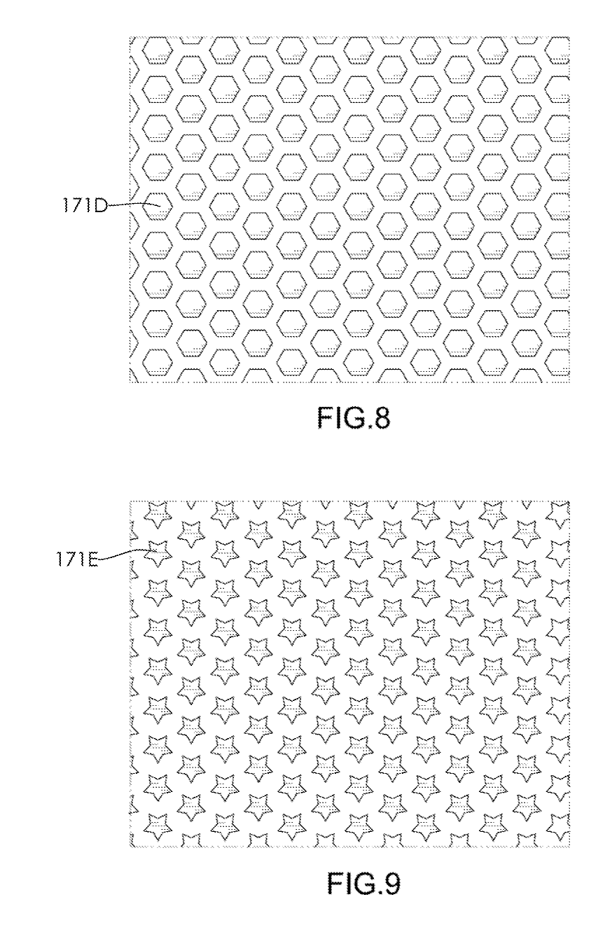

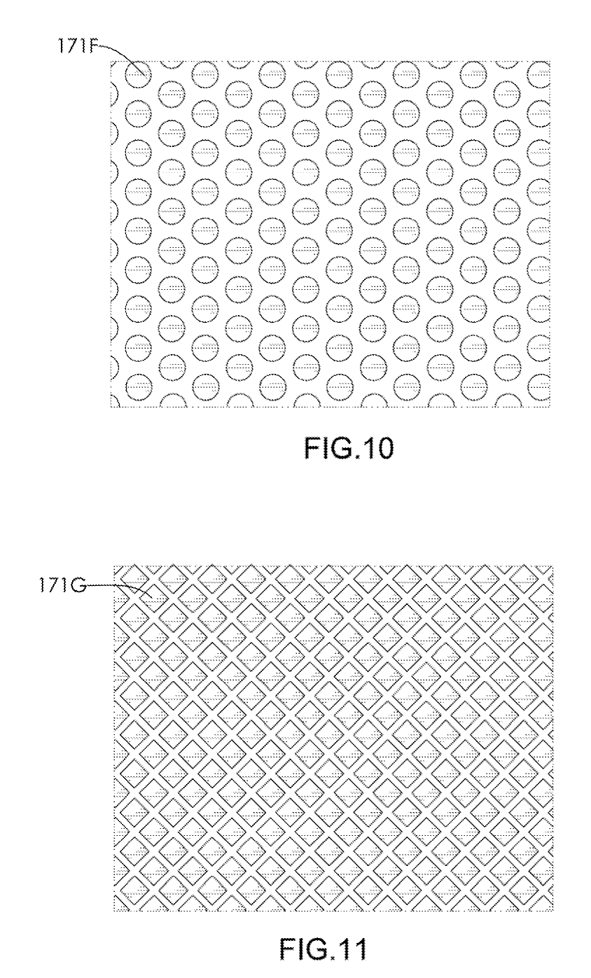

The mounting segment may be formed in different shapes. In one embodiment as shown in FIG. 3, each mounting segment 171 is pentagonal. In one embodiment as shown in FIG. 6, each mounting segment 171B is triangular. In one embodiment as shown in FIG. 7, each mounting segment 171C is quadrangular. in one embodiment as shown in FIG. 8, each mounting segment 171D is hexagonal. in one embodiment as shown in FIG. 9, each mounting segment 171E is star-shaped. In one embodiment as shown in FIG. 10, each mounting segment 171F is circular. In one embodiment as shown in FIG. 11, each mounting segment 171G is rhombus.

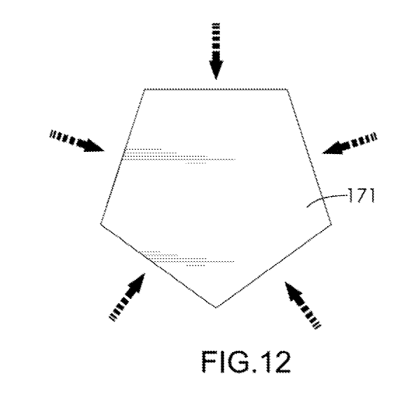

With reference to FIG. 12, a force the mounting segment 171 can resist is the biggest when the force is perpendicular to any one side of the mounting segment 171. Therefore, the pentagonal mounting segment 171 can most effectively resist force in five directions to prevent the tile from moving relative to the ground. To sum up, the glue-free vinyl tile can resist effectively various kinds of stress, which will make the tile deformed, and after long time of using, the glue-free vinyl tile is not domed or curled easily.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A glue-free vinyl the comprising:
a scratch proof layer;
an abrasion proof layer attached to a bottom of the scratch proof layer;
a printing layer attached to a bottom of the abrasion proof layer;
an upper PVC layer attached to a bottom of the printing layer;
a fiber layer attached to a bottom of the upper PVC layer;
a lower PVC layer attached to a bottom of the fiber layer; and
an anti-slip layer attached to a bottom of the lower PVC layer; and having multiple mounting segments formed on a bottom of the anti-slip layer and arranged in order.

2. The glue-free vinyl tile as claimed in claim 1, wherein the anti-slip layer is made of elastomer.

3. The glue-free vinyl tile as claimed in claim 1, wherein each mounting segment of the anti-slip layer is a protrusion.

4. The glue-free vinyl the as claimed in claim 2, wherein each mounting segment of the anti-slip layer is a protrusion.

5. The glue-free vinyl tile as claimed in claim 1, wherein each mounting segment of the anti-slip layer is a recess,

6. The glue-free vinyl tile as claimed in claim 2, wherein each mounting segment of the anti-slip layer is a recess.

7. The glue-free vinyl tile as claimed in claim 1, wherein the position of the fiber layer is above the middle height of the tile.

8. The glue-free vinyl tile as claimed in claim 4, wherein the position of the fiber layer is above the middle height of the tile.

9. The glue-free vinyl tile as claimed in claim 1, wherein the fiber layer is made of glass fiber.

10. The glue-free vinyl tile as claimed in claim 8, wherein the fiber layer is made of glass fiber.

11. The glue-free vinyl the as claimed in claim 10, wherein each mounting, segment of the anti-slip layer is triangular.

12. The glue-free vinyl tile as claimed in claim 10, wherein each mounting segment of the anti-slip layer is quadrangular.

13. The glue-free vinyl tile as claimed in claim 10, wherein each mounting segment of the anti-slip layer is pentagonal.

14. The glue-free vinyl tile as claimed in claim 10, wherein each mounting segment of the anti-slip layer is hexagonal.

15. The glue-free vinyl tile, as claimed in claim 10, wherein each mounting segment of the anti-slip layer is star-shaped.

16. The glue-free vinyl tile as claimed in claim 10, wherein each mounting segment of the anti-slip layer is circular.

17. The glue-free vinyl tile as claimed in claim 10, wherein each mounting segment of the anti-slip layer is rhombus.
